(19) United States
(12) Patent Application Publication
(10) Pub. No.: US 2011/0178665 A1
(43) Pub. Date: Jul. 21, 2011

(54) CONTROLLER FOR HYBRID SYSTEM

(75) Inventors: Mamoru YOSHIOKA, Susono-shi (JP); Fumito CHIBA, Susono-shi (JP); Takahiro TSUKAGOSHI, Susono-shi (JP)

(73) Assignee: Toyota Jidosha Kabushiki Kaisha, Toyota-Shi (JP)

(21) Appl. No.: 13/009,187

(22) Filed: Jan. 19, 2011

(30) Foreign Application Priority Data
Jan. 20, 2010 (JP) JP2010-010291

(51) Int. Cl. G06F 19/00

(52) U.S. Cl. 701/22; 180/65.27; 903/903

(57) ABSTRACT

A controller for the hybrid system includes: an alcohol concentration detector that detects alcohol concentration of fuel; a demanded coolant temperature setting device that sets a demanded coolant temperature higher as the alcohol concentration increases; an internal combustion engine stopped state determination device that determines whether an internal combustion engine is stopped; an external electric power source connection determination device that determines whether a storage battery is connected to an external electric power source; and a coolant pre-heating device that supplies electric power to a coolant heater until coolant temperature of the coolant reaches the demanded coolant temperature if the internal combustion engine is in the stopped state and the storage battery is connected to the external electric power source.

### CROSS-REFERENCE TO RELATED APPLICATIONS

This application claims priority to Japanese Patent Application No. 2010-010291 filed on Jan. 20, 2010, which is incorporated herein by reference in its entirety including the specification, drawings and abstract.

### BACKGROUND OF THE INVENTION

1. Field of the Invention

This invention relates to a controller for a hybrid system and, particularly, to a hybrid system controller that controls a plug-in hybrid system that is mounted in a vehicle.

2. Description of the Related Art

There is a known plug-in type hybrid system that has an internal combustion engine and an electric motor, and that is equipped with a storage battery that supplies electric power to the electric motor and that is capable of being charged through the use of an external electric power source, as disclosed in Japanese Patent Application Publication No. 2009-167875 (JP-A-2009-167875). Japanese Patent Application Publication No. 2004-324544 (JP-A-2004-324544) discloses a heater that heats coolant for an internal combustion engine when the heater supplied with electric power. Due to the coolant being heated by the heater, the startability of the internal combustion engine can be improved. Furthermore, Japanese Patent Application Publication No. 2009-180130 (JP-A-2009-180130) discloses an internal combustion engine that uses a mixture of alcohol and gasoline.

Some hybrid systems as described above employ an above-described internal combustion engine that uses a mixture of alcohol and gasoline. However, alcohol less readily vaporizes than gasoline, and may deteriorate the startability of the internal combustion engine. To cope with this problem, it is conceivable to heat the coolant for the internal combustion engine and thereby warm up the engine to accelerate the vaporization of the mixed fuel by using a heater as described above.

In this case, in order to secure an amount of heat of the coolant that is needed for the warm-up of the engine, it is necessary to appropriately raise the temperature of the coolant before the internal combustion engine is started. However, in order to keep the coolant temperature of the coolant high through the use of the heater for the purpose of the next starting of the engine, electric power from the storage battery needs to be consumed. When electric power of the storage battery has been consumed, the fuel economy following a start of traveling of the vehicle will deteriorate. Besides, the alcohol concentration of the fuel that is fed to the vehicle is not always constant, and the amount of heat of the coolant needed for the warm-up of the engine also changes.

### SUMMARY OF THE INVENTION

The invention provides a controller for a hybrid system that includes: an internal combustion engine that uses an alcohol-mixed fuel; a storage battery that is chargeable by using an external electric power source; and a device that heats coolant for the internal combustion engine when the device is supplied with electric power, the controller being capable of improving the startability of the internal combustion engine and of charging the storage battery.

A first aspect of the invention relates to a controller for a hybrid system that includes: an internal combustion engine that uses a fuel mixed with alcohol; a coolant heater that heats coolant for the internal combustion engine when the heater is supplied with electric power; and a storage battery that supplies electric power to the coolant heater, and that is charged at least when the storage battery is connected to an external electric power source. The controller for the hybrid system includes: an alcohol concentration detector that detects alcohol concentration of the fuel; a demanded coolant temperature setting device that sets a demanded coolant temperature higher as the alcohol concentration increases; an internal combustion engine stopped state determination device that determines whether the internal combustion engine is stopped; an external electric power source connection determination device that determines whether the storage battery is connected to the external electric power source; and a coolant pre-heating device that supplies electric power to the coolant heater until coolant temperature of the coolant reaches the demanded coolant temperature if the internal combustion engine is in the stopped state and the storage battery is connected to the external electric power source.

According to the foregoing aspect, the higher the alcohol concentration of the fuel, the higher the demanded temperature is set. If the internal combustion engine is in the stopped state and the storage battery is connected to an external electric power source, the coolant can be heated until the demanded temperature is reached. Therefore, an amount of heat needed for the warm-up of the internal combustion engine can be secured, and the startability of the internal combustion engine can be heightened. On the other hand, the lower the alcohol concentration of the fuel, the lower the demanded temperature is set. Therefore, in a situation where the amount of heat of the cooling temperature needed for the warm-up of the engine is small, excess supply of electric power to the coolant heater can be restrained. Therefore, the storage battery can be favorably charged by an external electric power source, and the fuel economy following a start of traveling of the vehicle can be improved.

A second aspect of the invention also relates to a controller for a hybrid system that includes: an internal combustion engine that uses a fuel mixed with alcohol; coolant heating means for heating coolant for the internal combustion engine when the heating means is supplied with electric power; and a storage battery that supplies electric power to the coolant heating means, and that is charged at least when the storage battery is connected to an external electric power source. The controller for the hybrid system includes: alcohol concentration detection means for detecting alcohol concentration of the fuel; demanded coolant temperature setting means for setting a demanded coolant temperature higher as the alcohol concentration increases; internal combustion engine stopped state determination means for determining whether the internal combustion engine is stopped; external electric power source connection determination means for determining whether the storage battery is connected to the external electric power source; and coolant pre-heating means for supplying electric power to the coolant heating means until coolant temperature of the coolant reaches the demanded coolant temperature if the internal combustion engine is in the stopped state and the storage battery is connected to the external electric power source.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a diagram showing a general construction of a traction system of a plug-in type hybrid vehicle to which a first embodiment of the invention is applied;

FIG. 2 is a diagram for describing a cooling system and a heat storage system that are provided in a hybrid system of the first embodiment of the invention;

FIG. 3 is a diagram showing relations among the outside air temperature, the ethanol concentration of fuel, and the demanded coolant temperature for use in a control in the first embodiment of the invention;

FIG. 4 is a flowchart of a heat-storing coolant pre-heating control routine that an ECU executes in the first embodiment of the invention;

FIG. 5 is a diagram for describing a heat-storing coolant temperature raise priority map for use in a system in a second embodiment of the invention;

FIG. 6 is a flowchart of a heat-storing coolant pre-heating routine control that an ECU executes in the second embodiment of the invention;

FIG. 7 is a diagram for describing a heat-storing coolant temperature raise priority map for use in a system in a third embodiment of the invention;

FIG. 8 is a flowchart of a heat-storing coolant pre-heating routine control that an ECU executes in the third embodiment of the invention;

FIG. 9 is a diagram for describing a demanded coolant temperature map for use in a system in a fourth embodiment of the invention;

FIG. 10 is a flowchart of a heat-storing coolant pre-heating routine control that an ECU executes in the fourth embodiment of the invention;

FIG. 11 is a diagram showing changes in the coolant temperature in an engine after the engine stops; and

FIG. 12 is a diagram showing changes in the temperature of the coolant kept is a heat-storing state in a heat storage tank after the engine stops.

### DETAILED DESCRIPTION OF EMBODIMENTS

Hereinafter, embodiments of the invention will be described with reference to the accompanying drawings. The same or like components in the drawings are denoted by the same reference characters, and will not be redundantly described.

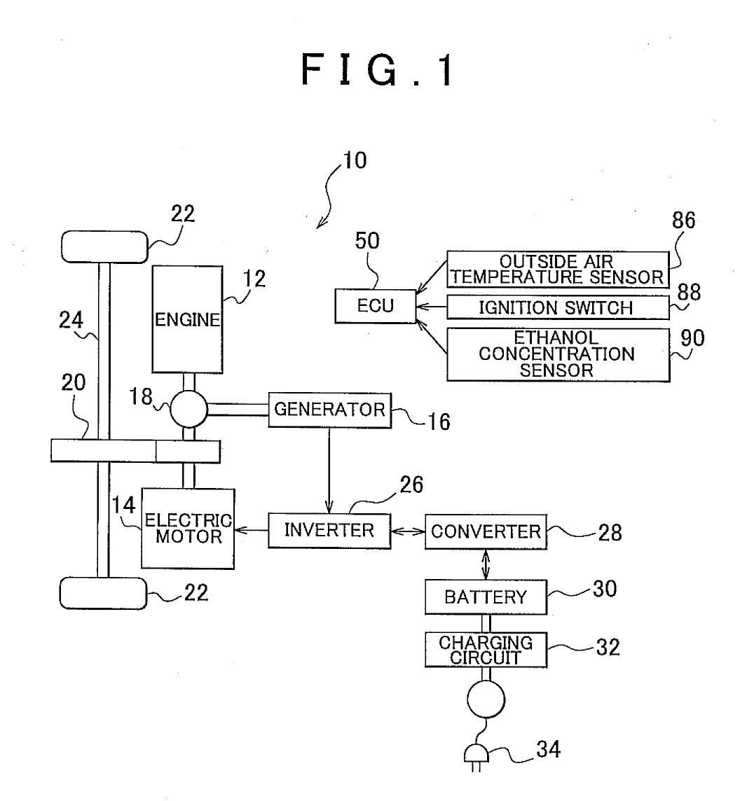

FIG. 1 is a diagram showing a general construction of a traction system of a plug-in type hybrid vehicle of a first embodiment to which the invention is applied. A traction system 10 in this embodiment includes an internal combustion engine (hereinafter, simply referred to as “engine”) 12 as a motive power source of the vehicle, and a vehicle traction motor (hereinafter, simply referred to as “motor”) 14. The fuels usable by the engine 12 include gasoline and alcohol, and also a mixture of gasoline and alcohol. The alcohol used herein is, for example, ethanol. Besides, the traction system 10 further includes an electricity generator 16 that generates electric power when the electricity generator 16 is supplied with driving force.

The engine 12, the motor 14 and the electricity generator 16 are linked to each other via a power splitting mechanism 18. A speed reducer 20 is connected to a rotary shaft of the motor 14 that is connected to the power splitting mechanism 18. The speed reducer 20 interlinks the rotary shaft of the motor 14 and a drive shaft 24 that connects to the driving wheels 22. The power splitting mechanism 18 divides the driving force from the internal combustion engine 12 to the electricity generator 16 and to the speed reducer 20. The distribution ratio of the driving force by the power splitting mechanism 18 can be arbitrarily altered.

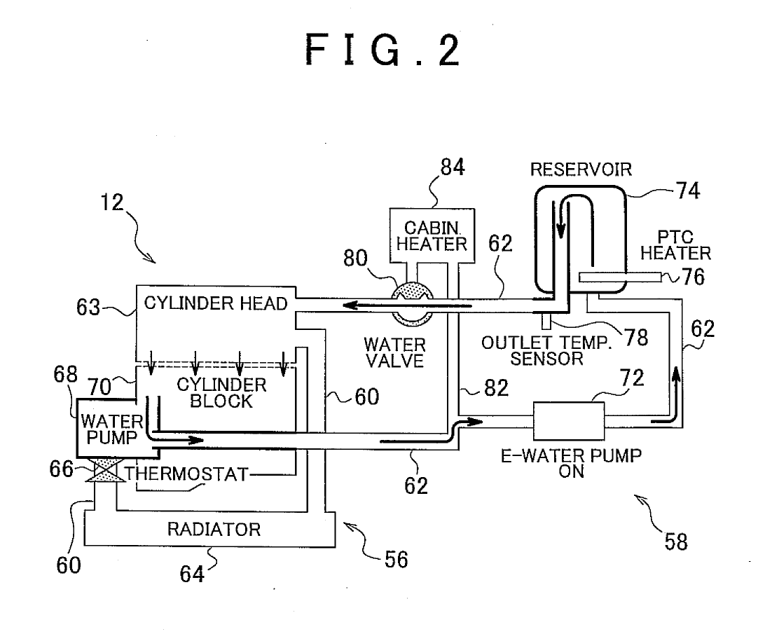

The traction system 10 further includes an inverter 26, a converter 28 and a battery 30. The inverter 26 is connected to the electricity generator 16 and the motor 14, and is also connected to the battery 30 via the converter 28. The electric power generated by the electricity generator 16 can be supplied to the motor 14 via the inverter 26, and can also be stored in the battery 30 via the inverter 26 and the converter 28. The electric power stored in the battery 30 can be supplied to the motor 14 via the converter 28 and the inverter 26, and can also be supplied to an electrically driven water pump 72 and a heater 76 that are shown in FIG. 2 and will be described later.

The battery 30 is constructed so as to be capable of being supplied with electric power from an external electric power source (a home electrical power source, a dedicated electric power source provided at a charging station, etc.). The battery 30 is connected to a charging plug 34 via a charging circuit 32. When the charging plug 34 is connected to an external electric power source, the battery 30 can be supplied with electric power from the external electric power source, and thus can be charged. That is, the traction system 10 of this embodiment is constructed as a traction system of a so-called plug-in type hybrid vehicle.

According to the traction system 10 described above, it is possible to rotate the drive wheels 22 by using only the driving force from the internal combustion engine 12 while the motor 14 is being stopped and to rotate the driving wheels 22 by using only the traction forth from the motor 14 while the internal combustion engine 12 is being stopped, on the basis of predetermined conditions. Furthermore, it is also possible to operate both the motor 14 and the internal combustion engine 12 so that the driving wheels 22 are rotated by the driving force from the two motive power sources.

Besides, according to the traction system 10, the motor 14 can be used as a starter of the internal combustion engine 12. That is, when starting the internal combustion engine 12, a portion or the entire amount of the driving force of the motor 14 can be input to the internal combustion engine 12 via the power splitting mechanism 18 so as to crank the internal combustion engine 12.

FIG. 2 is a diagram for describing a cooling system 56 and a heat storage system 58 that are provided in the hybrid system of this embodiment. Firstly, the cooling system 56 provided for the engine 12 will be described. The engine 12 is connected to a cooling passageway 60 for circulating coolant. An upstream end of the cooling passageway 60 is connected to a flow channel that is formed within a cylinder head 63 of the engine 12. The cooling passageway 60 downstream of the cylinder head 63 is connected to a radiator 64.

The radiator 64 is a heat exchanger that allows heat exchange between the coolant that flows in and the external air, and is constructed so that the coolant having been subjected to the heat exchange is discharged into the cooling passageway 60 downstream of the radiator 64. The cooling passageway 60 downstream of the radiator 64 is provided with a cooling passageway temperature sensor 66. The cooling passageway 60 downstream of the cooling passageway temperature sensor 66 is connected to a coolant suction opening of a mechanical water pump 68.

The mechanical water pump 68 generates flow of the coolant by using rotating torque of an output shaft of the engine 12 as a power source. The mechanical water pump 68 is constructed so that the coolant sucked in through the coolant suction opening is discharged through a coolant discharge opening. The coolant discharge opening of the mechanical water pump 68 is connected to a flow channel that is formed in a cylinder block 70 of the engine 12.

The cylinder block 70 and the cylinder 63 are fastened together, and the flow channels formed therein are connected to each other. The coolant having flown into the cylinder block 70 is discharged from the cylinder head 63, and is returned to the radiator 64.

Next, the heat storage system 58 provided for the engine 12 will be described. A heating passageway 62 in which the coolant is circulated is connected to the engine 12. An upstream end of the heating passageway 62 is connected to a flow channel that is formed within the cylinder block 70. The heating passageway 62 downstream of the cylinder block 70 is connected to a coolant suction opening of the electrically driven water pump 72.

The electrically driven water pump 72 generates flow of the coolant by using electric power output from the battery 30 as a power source. The electrically driven water pump 72 is constructed so that the coolant sucked in from the coolant suction opening is discharged at a coolant discharge opening.

The heating passageway 62 downstream of the coolant discharge opening of the electrically driven water pump 72 is provided with a heat storage tank 74. The heat storage tank 74 is a container that keeps the coolant in a state where heat is stored (coolant kept in a heat-storing state). A heater 76 for heating the coolant stored in the heat storage tank 74 is provided inside the heat storage tank 74. The heater 76 used herein may be, for example, a PTC (Positive Temperature Coefficient) heater. The heater 76 is constructed so as to heat the coolant when the heater 76 is supplied with electric power from the battery 30.

A heating passageway temperature sensor 78 that detects the temperature of the coolant kept in the heat storage tank 74 is provided near an outflow opening of the heat storage tank 74. The heating passageway 62 downstream of the heat storage tank 74 is provided with a flow channel switch valve 80. An end of a branch passageway 82 is connected to the flow channel switch valve 80. Another end of the branch passageway 82 is connected to the heating passageway 62 upstream of the electrically driven water pump 72. Besides, the branch passageway 82 is provided with a cabin heater 84. The flow channel switch valve 80 is driven by an electric motor or the like, and is capable of selectively opening and closing the heating passageway 62 and the branch passageway 82.

The heating passageway 62 downstream of the flow channel switch valve 80 is connected to a flow channel that is formed in the cylinder head 63. The coolant having flown into the cylinder head 63 is returned to the cooling passageway 60 and the heating passageway 62.

The hybrid system of this embodiment is equipped with an ECU (Electronic Control Unit) 50 (see FIG. 1). Various sensors are connected to an input side of the ECU 50, including the charging circuit 32, the cooling passageway temperature sensor 66 and the heating passageway temperature sensor 78 and, furthermore, an external air temperature sensor 86 (FIG. 1), an ignition switch 88 (FIG. 1), an ethanol concentration sensor 90 (FIG. 1) that detects the ethanol concentration of fuel, etc. Various actuators are connected to an output side of the ECU 50, including the charging circuit 32, the electrically driven water pump 72, the heater 76, the flow channel switch valve 80, etc.

On the basis of information input from various sensors, the ECU 50 executes a predetermined program and operates various actuators so as to control the traction system 10 and the heat storage system 58. With regard to the traction system 10, the ECU 50 is able to carry out an EV mode, an HV mode, etc., by integrally controlling the entire system that includes the engine 12, the motor 14, the electricity generator 16, the power splitting mechanism 18, the inverter 26, the converter 28, the charging circuit 32, etc.

With regard to the heat storage system 58, the ECU 50 is able to turn on the electrically driven water pump 72. When the electrically driven water pump 72 is turned on, the electrically driven water pump 72 causes fresh coolant to flow into the heat storage tank 74 so that the coolant kept in the heat-storing state in the heat storage tank 74 is extruded. Furthermore, the flow channel switch valve 80 is caused to open the heating passageway 62, so that the coolant extruded from the heat storage tank 74 is supplied to the engine 12. Thus, by supplying the coolant kept in the heat-storing state from the heat storage tank 74 to the engine 12 when starting the engine 12, the engine 12 (the intake ports, the cylinders, etc.) can be warmed up according to the total amount of heat of the warm coolant (the amount and coolant temperature) supplied to the engine 12.

Furthermore, with regard to the heat storage system 58, the ECU 50 is able to turn on the heater 76. When the heater 76 is turned on, the heater 76 is supplied with electric power from the battery 30 to generate heat. Therefore, the coolant kept in the heat-storing state within the heat storage tank 74 is heated.

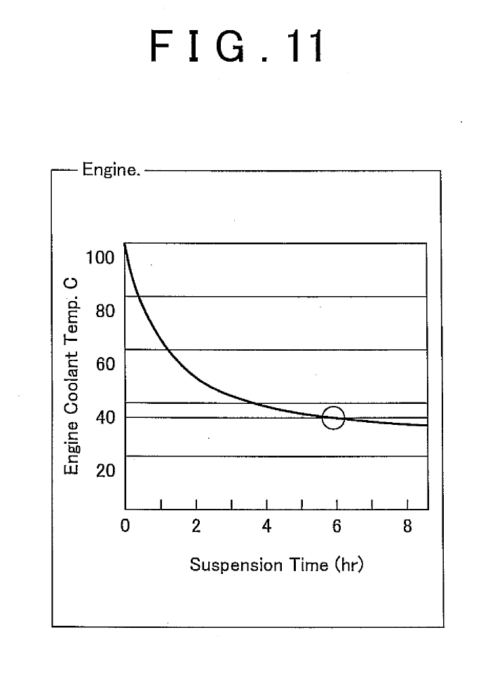

The temperature of the coolant for the engine 12 and the temperature of the coolant for the heat storage tank 74 become lower the longer the suspension time (i.e., the time from a stop of the engine till the subsequent start thereof). FIG. 11 is a diagram showing changes in the coolant temperature in the engine 12 after the engine 12 has stopped. As shown in FIG. 11, the temperature of the coolant for the engine 12 sharply drops after the engine stops. If the coolant temperature greatly drops, the low coolant temperature will become a factor that deteriorates the engine startability when the engine 12 is started.

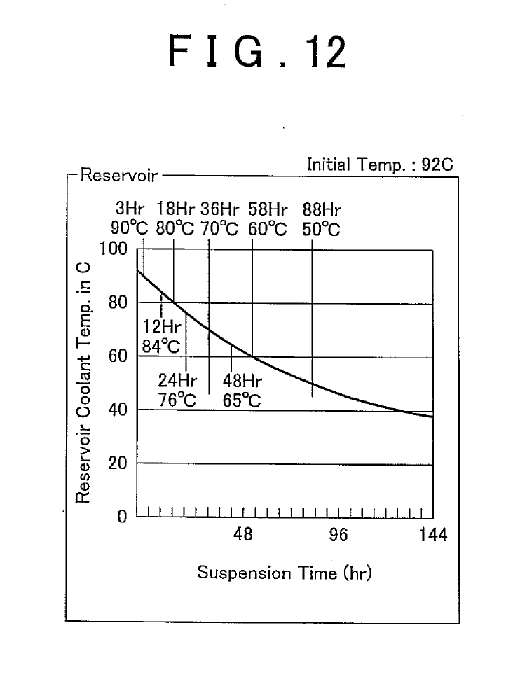

FIG. 12 is a diagram showing changes in the coolant temperature kept in the heat storage tank 74 following a stop of the engine. As shown in FIG. 12, the temperature of the coolant kept in the heat-storing state in the heat storage tank 74 gently drops after the engine stops. Although the heat storage tank is a heat retentive tank, temperature drop of the coolant is inevitable if the suspension time is long. Therefore, when the engine 12 is to be started, the coolant stored in the heat-storing state supplied to the engine 12 may not have sufficient amount of heat that is needed for the warm-up of the engine 12.

In particular, the engine 12 of the traction system 10 uses an ethanol-mixed fuel as mentioned above. Since ethanol less readily vaporizes than gasoline, the amount of heat that the coolant supplied to the engine 12 needs to have for the warm-up of the engine 12 varies depending on the ethanol concentration of the fuel fed to the vehicle.

To cope with this problem, it is conceivable to always keep the coolant at high temperature by using the heater 76. However, this consumes large amount of electric power of the battery 30, and will result in a low state of charge of the battery 30. If the state of charge in the battery 30 becomes low, the fuel economy following a start of traveling of the vehicle will deteriorate.

Therefore, in the hybrid system of this embodiment, the heat storage system 58 is employed in the traction system 10 of the plug-in type hybrid system, and in this construction, a heating control of the coolant kept in the heat-storing state stored in the heat storage tank 74 to a temperature that is needed for the engine warm-up is carried out during the suspension time according to the ethanol concentration of the fuel, the state of connection to an external electric power source, etc.

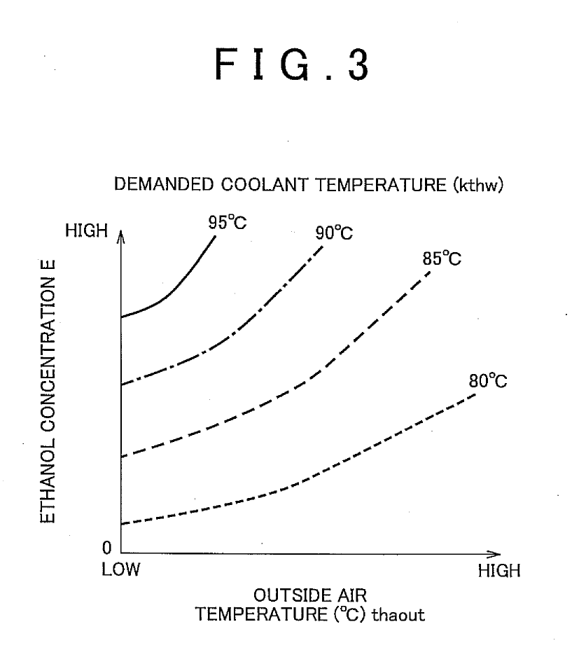

The control will be more concretely described. FIG. 3 is a diagram for describing a “demanded coolant temperature map” that is used in the hybrid system of the first embodiment. The demanded coolant temperature map in FIG. 3 represents relations among the outside air temperature thaout, the ethanol concentration E in fuel and the demanded coolant temperature kthw. The demanded coolant temperature kthw is the coolant temperature for securing the amount of heat that is needed for the warm-up of the engine 12 in order to start the engine 12, and is the temperature of coolant kept in the heat-storing state within the heat storage tank 74.

The higher the outside air temperature is, the more readily fuel vaporizes, and the higher the startability of the engine 12 becomes. Therefore, as shown in FIG. 3, the higher the outside air temperature thaout is, the lower the demanded coolant temperature kthw is set. Besides, ethanol less readily vaporizes than gasoline. Therefore, the higher the ethanol concentration E in the fuel is, the higher the demanded coolant temperature kthw is set in order to accelerate the vaporization of the fuel.

When the hybrid system of this embodiment is connected to an external electric power source, the demanded coolant temperature kthw is set higher the lower the outside air temperature thaout is and the higher the ethanol concentration E is, and the coolant is heated until the demanded coolant temperature kthw is reached, so as to secure the amount of heat that is needed for the warm-up of the engine 12. When the temperature of the coolant has reached the demanded coolant temperature kthw, the excess heating is stopped to accelerate the charging of the battery 30 by the external electric power source.

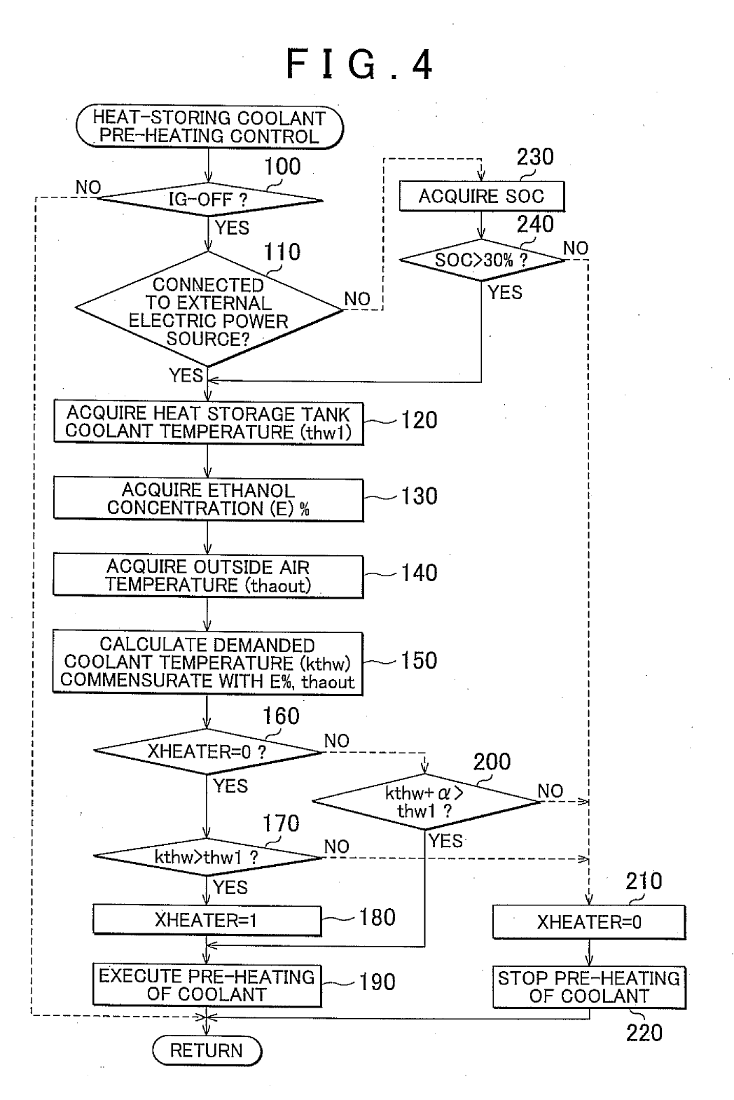

FIG. 4 is a flowchart of a heat-storing coolant pre-heating control routine that the ECU 50 executes in order to realize the foregoing operations. The heat-storing coolant pre-heating control routine is repeated in a predetermined time. In the routine shown in FIG. 4, it is firstly determined in step 100 whether or not the ignition device is off. Concretely, if an ignition switch 88 is off, it is determined that the ignition device is off. If it is determined that the ignition device is on, the process of this routine ends.

If it is determined that the ignition device is off, it is then determined in step 110 whether or not the battery 30 has been connected to an external electric power source. Concretely, the presence/absence of the connection between the battery 30 and the external electric power source is detected by the charging circuit 32. As described above, when the battery 30 is connected to the external electric power source, electric power is supplied from the external electric power source to charge the battery 30.

If it is determined that the external electric power source has been connected to the battery 30, the process proceeds to step 120, in which the ECU 50 acquires the heat storage tank coolant temperature thw1 that is the temperature of the coolant kept in the heat-storing state within the heat storage tank 74. The heat storage tank coolant temperature thw1 is detected by the heating passageway temperature sensor 78.

Subsequently in step 130, the ethanol concentration E in the fuel is acquired. The ethanol concentration E is detected by the ethanol concentration sensor 90. In step 140, the outside air temperature thaout is acquired. The outside air temperature thaout is detected by the outside air temperature sensor 86.

After that, in step 150, a demanded coolant temperature kthw is calculated. The “demanded coolant temperature map” described above with reference to FIG. 3 is pre-stored in the ECU 50. From the demanded coolant temperature map, the ECU 50 acquires a demanded coolant temperature kthw that corresponds to the ethanol concentration E acquired in step 130 and the outside air temperature thaout acquired in step 140. Incidentally, the demanded coolant temperature kthw is determined beforehand by experiments or the like so as to secure the amount of heat needed for the warm-up of the engine 12, by taking into account the material and structure of the engine 12, the amount of coolant kept in the heat storage tank 74, etc.

Subsequently, in step 160, it is determined whether or not a coolant pre-heating execution flag XHEATER is “0”. The coolant pre-heating execution flag XHEATER is pre-stored in the ECU 50, and the initial value thereof is set at “0”.

If it is determined that the coolant pre-heating execution flag XHEATER is “0”, it is then determined in step 170 whether or not the demanded coolant temperature kthw is higher than the coolant temperature thw1 of the coolant kept in the heat-storing state within the heat storage tank which is acquired in step 120. If it is determined that the demanded coolant temperature kthw is higher than the coolant temperature thw1 of the coolant kept in the heat-storing state within the heat storage tank, the ECU 50 can determine that the temperature of the coolant kept in the heat-storing state within the heat storage tank 74 is not so high that the amount of heat needed for the warm-up of the engine 12 can be secured. In this case, in step 180, “1” is set for the coolant pre-heating execution flag XHEATER.

In the case where “1” is set in the coolant pre-heating execution flag XHEATER, the ECU 50 executes the coolant pre-heating (step 190). Concretely, the ECU 50 turns on the heater 76. After that, the process of this routine ends.

On the other hand, if in step 170 it is determined that the demanded coolant temperature kthw is less than or equal to the coolant temperature thw1 of the coolant kept in the heat-storing state within the heat storage tank, the ECU 50 can determine that the coolant kept in the heat-storing state within the heat storage tank 74 certainly has an amount of heat that is sufficient for the warm-up of the engine 12. In this case, “0” is set for the coolant pre-heating execution flag XHEATER (step 210). In the case where “0” is set for the coolant pre-heating execution flag XHEATER, the coolant pre-heating is stopped (step 220). Concretely, the ECU 50 turns off the heater 76. After that, the process of this routine is ended.

Besides, if in the subsequent or a later cycle of this routine, it is determined in step 160 that the value of the coolant pre-heating execution flag XHEATER is “1”, it is then determined in step 200 whether or not the temperature value obtained by adding a predetermined value α to the demanded coolant temperature kthw is higher than the heat storage tank coolant temperature thw1. The predetermined value α is a value for absorbing a detection error of the heating passageway temperature sensor 78. By adding the predetermined value α, it becomes possible to prevent the heater 76 from repeatedly turning on and off in a short time.

If the determination condition in step 200 is satisfied, the coolant pre-heating is performed by the foregoing process of step 190. On the other hand, if the determination condition in step 200 is not satisfied, the coolant pre-heating is stopped by the foregoing process of step 210 and step 220.

If in step 110 it is determined that the battery 30 is not connected to an external electric power source, the state of charge SOC of the battery 30 is acquired in step 230. The state of charge SOC is detected by the charging circuit 32.

Subsequently in step 240, it is determined whether or not the state of charge SOC of the battery 30 is higher than a prescribed value. The prescribed value is set, for example, at 30%. If it is determined that the state of charge SOC is higher than the prescribed value, the ECU 50 can determine that the state of charge SOC of the battery 30 is sufficient or ample. In that case, the foregoing process starting in step 120 is executed. On the other hand, if it is determined that the state of charge SOC is less than or equal to the prescribed value, the ECU 50 can determine that the state of charge SOC of the battery 30 is insufficient. In that case, the foregoing process starting in step 210 is performed without execution of the coolant pre-heating, and then the process of this routine is ended.

As described above, according to the routine shown in FIG. 4, the demanded coolant temperature kthw can be set higher the higher the ethanol concentration E and the lower the outside air temperature thaout. Since the demanded coolant temperature kthw is set comparatively high and the coolant pre-heating is accordingly executed, the amount of heat needed for the warm-up of the engine 12 can be secured. Therefore, decline of the startability of the engine 12 can be restrained.

Besides, according to the routine shown in FIG. 4, the demanded coolant temperature kthw can be set lower the lower the ethanol concentration E and the higher the outside air temperature thaout. In the case where the ethanol concentration E is relatively low and the outside air temperature thaout is relatively high, the amount of heat that needs to be used for the engine warm-up is small. Therefore, in this case, by setting the demanded coolant temperature kthw relatively low, the electric power consumption of the heater 76 can be restrained. Hence, the charging of the battery 30 connected to the external electric power source can be accelerated.

Thus, according to the hybrid system of this embodiment, since the demanded coolant temperature kthw is appropriately set in accordance with the ethanol concentration E and the outside air temperature thaout, so that the amount of heat needed for the engine warm-up can be secured, and unnecessary consumption of electric power can be restrained to correspondingly accelerate the charging of the battery 30. Therefore, improved startability of the internal combustion engine and improved fuel economy following a start of traveling of the vehicle can be realized.

Although in the foregoing hybrid system of the first embodiment, the coolant pre-heating is realized by switching the heater 76 on and off, the method of carrying out the coolant pre-heating is not limited so. For example, it is permissible to adopt an arrangement in which the heater 76 is constructed so that its electric power consumption can be changed, and the amount of electric power supplied to the heater 76 is made larger the higher the demanded coolant temperature kthw in step 190. As shown in FIGS. 11 and 12, the higher range the temperature of the coolant is in, the greater the decrease in the temperature per unit time is. Therefore, the higher the demanded coolant temperature kthw, the larger the electric power amount supplied to the heater 76 is made. Thus, the temperature of the coolant can be promptly raised. This applies in the same manner in the following embodiments, too.

Besides, in the foregoing hybrid system of the first embodiment, the ratio between the electric power supplied to the battery 30 and to the heater 76 from an external electric power source may be changed. Concretely, a circuit that keeps the amount of electric power supplied from an external electric power source to be constant is provided. This circuit is connected to the charging circuit 32 and to the heater 76. In step 190, the amount of electric power supplied to the heater 76 may be made larger the higher the demanded coolant temperature kthw. Therefore, the amount of electric power that is stored into the battery 30 is relatively decreased, so that the heating of the coolant can be given priority. This applies in the same manner in the following embodiments as well.

Incidentally, in the first embodiment described above, the engine 12 may correspond to an “internal combustion engine” in the invention, and the motor 14 may correspond to a “motor” in the invention, and the heater 76 may correspond to a “coolant heater” in the invention, and the battery 30 may correspond to a “storage battery” in the invention, and the ethanol concentration sensor 90 may correspond to an “alcohol concentration detector” in the invention, and the outside air temperature sensor 86 may correspond to an “outside air temperature acquisition device” in the invention.

Besides, the ECU 50 realizes a “demanded coolant temperature setting device” in the invention by executing the process of step 150, and also realizes an “internal combustion engine stopped state determination device” in the invention by executing the process of step S100, an “external electric power source connection determination device” in the invention by executing the process of step 110, a “coolant pre-heating device” in the invention by executing the process of step 190, and a “charging ratio alteration device” in the invention by executing the process of step 190.

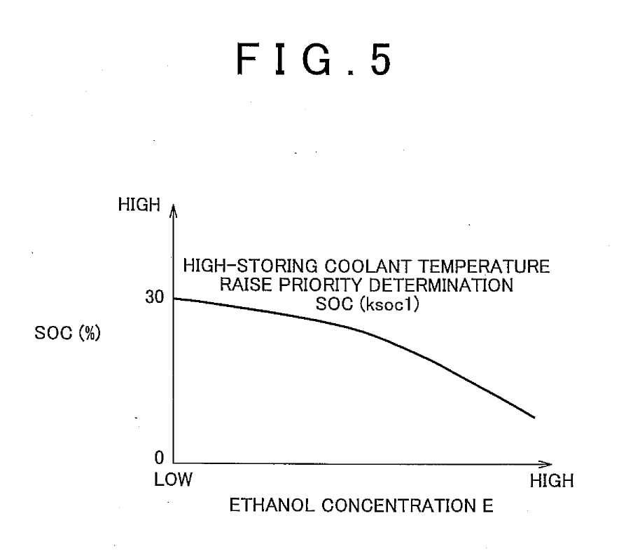

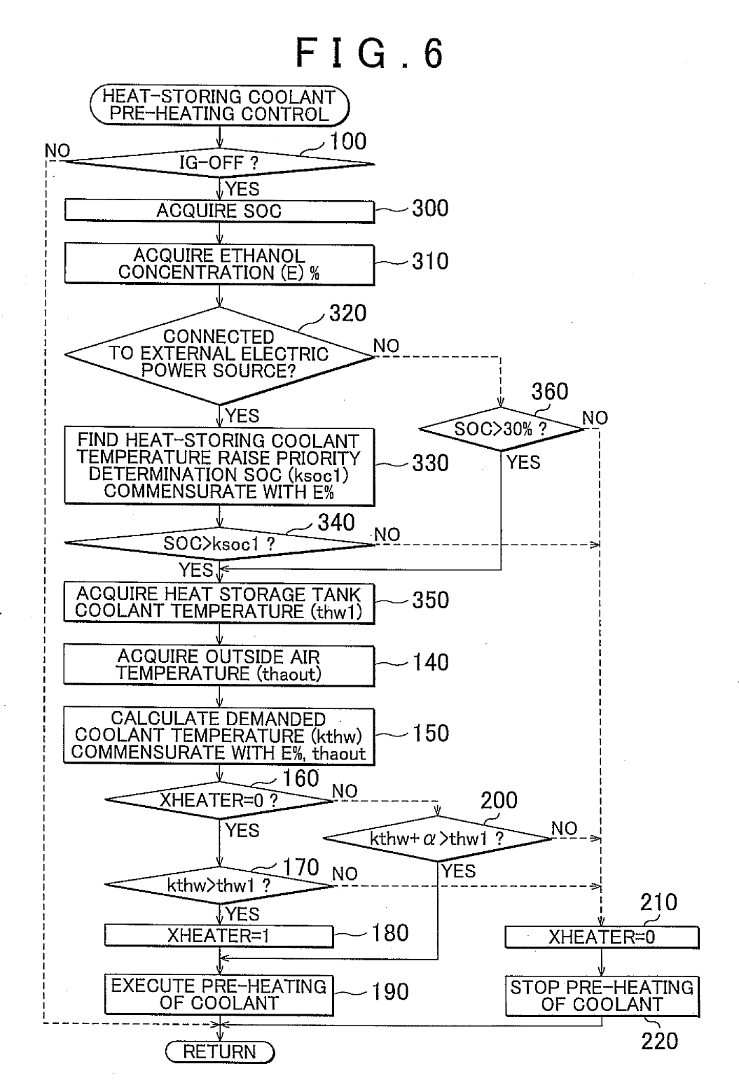

Next, a second embodiment of the invention will be described with reference to FIG. 5 and FIG. 6. A hybrid system in this embodiment can be realized by carrying out a routine shown in FIG. 6 which will be described below, in the construction as shown in FIGS. 1 and 2.

In the traction system 10 shown in FIG. 1, the ECU 50 is able to perform such a control as to maintain the state of charge of the battery 30 to a certain value (e.g., 30%) or greater by performing the HV mode if the state of charge of the battery 30 becomes less than or equal to the certain value. As described above, the higher the ethanol concentration of the fuel, the more the startability of the engine 12 deteriorates. Therefore, in some cases, securement of an engine startability needs to be given priority over securement of a state of charge of the battery 30. Therefore, in the hybrid system of this embodiment, the higher the ethanol concentration, the higher priority is given to the implementation of a control of heating the coolant kept in the heat-storing state within the heat storage tank 74 (hereinafter, also referred to simply as “coolant pre-heating”).

The control will be more concretely described. FIG. 5 is a diagram for describing a “heat-storing coolant temperature raise priority map” for use in the system of the second embodiment. The heat-storing coolant temperature raise priority map shown in FIG. 5 represents a relation between the ethanol concentration E in the fuel and a heat-storing coolant temperature raise priority criterion state of charge ksoc1. The heat-storing coolant temperature raise priority criterion state of charge ksoc1 is set lower the higher the ethanol concentration.

In the hybrid system of this embodiment, the heat-storing coolant temperature raise priority criterion state of charge ksoc1 is used as a criterion value. If the ethanol concentration E in the fuel is higher, in which case the fuel less readily vaporizes, the criterion value ksoc1 is set lower to correspondingly facilitate the execution of the coolant pre-heating. On the other hand, the lower the ethanol concentration E is, the criterion value ksoc1 is set higher to restrain the execution of the coolant pre-heating, so that the excess heating is stopped to accelerate the charging of the battery 30 from an external electric power source. That is, when the heat-storing coolant temperature raise priority criterion state of charge ksoc1 is greater than a predetermined state of charge, the coolant pre-heating is executed. The predetermined state of charge is set lower the higher the ethanol concentration E is.

FIG. 6 is a flowchart of a heat-storing coolant pre-heating control routine that the ECU 50 executes in order to realize the foregoing operations. This routine is substantially the same as the routine shown in FIG. 4, except that the process of step 110 to step 130 in FIG. 4 is replaced by the process of step 300 to 350, and that the process of step 230 to step 240 is replaced by step 360. Hereinafter, the steps in FIG. 6 that are the same as those shown in FIG. 4 are denoted by the same reference characters, and their descriptions will be omitted or simplified.

In the routine shown in FIG. 6, after the process of step 100, the state of charge SOC of the battery 30 is acquired (step 300). The state of charge SOC is detected by the charging circuit 32. Besides, the ethanol concentration E in the fuel is acquired (step 310). The ethanol concentration E is detected by the ethanol concentration sensor 90.

After that, in step 320, it is determined whether or not the battery 30 and an external electric power source are connected to each other. Concretely, the state of connection between the battery 30 and the external electric power source is detected by the charging circuit 32. As described above, when the battery 30 is connected to an external electric power source, the battery 30 is supplied with electric power from the external electric power source, and is thus charged.

If it is determined that an external electric power source has been connected to the battery 30, a heat-storing coolant temperature raise priority criterion state of charge ksoc1 is then calculated in step 330. The “heat-storing coolant temperature raise priority map” described above with reference to FIG. 5 is pre-stored in the ECU 50. From the heat-storing coolant temperature raise priority map, a heat-storing coolant temperature raise priority criterion state of charge ksoc1 that corresponds to the ethanol concentration E acquired in step 310 is acquired.

Subsequently, it is determined whether or not the state of charge SOC of the battery 30 acquired in step 300 is greater than the heat-storing coolant temperature raise priority criterion state of charge ksoc1 (step 340). If it is determined that the state of charge SOC is greater than the heat-storing coolant temperature raise priority criterion state of charge ksoc1, the heat storage tank coolant temperature thw1 that is the temperature of the coolant kept in the heat-storing state within the heat storage tank 74 is acquired (step 350). The heat storage tank coolant temperature thw1 is detected by the heating passageway temperature sensor 78. After that, substantially the same process as the foregoing process starting in step 140 in FIG. 4 is performed. If the condition is satisfied, the coolant pre-heating is executed (step 190).

On the other hand, if in step 340 it is determined that the state of charge SOC of the battery 30 is less than or equal to the heat-storing coolant temperature raise priority criterion state of charge ksoc1, substantially the same process as the foregoing process starting in step 210 in FIG. 4 is performed, so that the coolant pre-heating is stopped.

If in step 320 it is determined that an external electric power source is not connected to the battery 30, it is then determined in step 360 whether or not the state of charge SOC of the battery 30 is higher than a prescribed value. The prescribed value set herein is, for example, 30%. If it is determined that the state of charge SOC is higher than the prescribed value, the ECU 50 can determine that the state of charge SOC of the battery 30 is sufficient or ample. In this case, substantially the same process as the foregoing process starting in step 350 is executed. On the other hand, if it is determined that the state of charge SOC is less than or equal to the prescribed value, the ECU 50 can determine that the state of charge SOC of the battery 30 is insufficient. In this case, substantially the same process as the foregoing processes starting in step 210 is performed, and the present cycle of this routine process is ended without executing the coolant pre-heating.

As described above, according to the routine shown in FIG. 6, the heat-storing coolant temperature raise priority criterion state of charge ksoc1 can be set lower the higher the ethanol concentration E. The higher the ethanol concentration E in a fuel is, the less readily the fuel evaporates, and therefore the more the startability of the engine 12 deteriorates. However, in the case where the ethanol concentration E is higher, the heat-storing coolant temperature raise priority criterion state of charge ksoc1 is set lower, so that the securement of the amount of heat needed for the warm-up of the engine 12 can be performed with priority over the securement of a state of charge of the battery 30.

Besides, according to the routine shown in FIG. 6, the heat-storing coolant temperature raise priority criterion state of charge ksoc1 can be set higher the lower the ethanol concentration E. In the case where the ethanol concentration E is low, a good startability of the engine is secured, and therefore the heat-storing coolant temperature raise priority criterion state of charge ksoc1 can be set high to curb the electric power consumed by the heater 76. As a result, the charging of the battery 30 can be accelerated.

Thus, according to the hybrid system of this embodiment, the heat-storing coolant temperature raise priority criterion state of charge ksoc1 is appropriately set in accordance with the ethanol concentration E, so that improved startability of the internal combustion engine and improved fuel economy following a start of traveling of the vehicle can be realized.

Incidentally, in the second embodiment described above, the ECU 50 realizes an “external electric power source connection determination device” in the invention by executing the foregoing process of step 320.

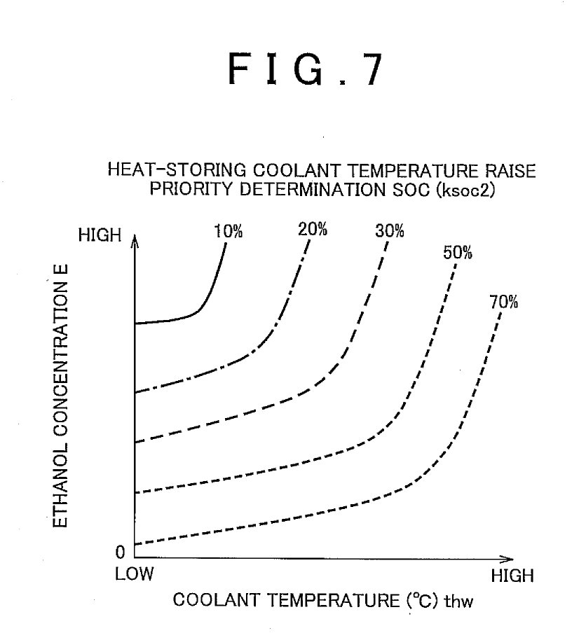

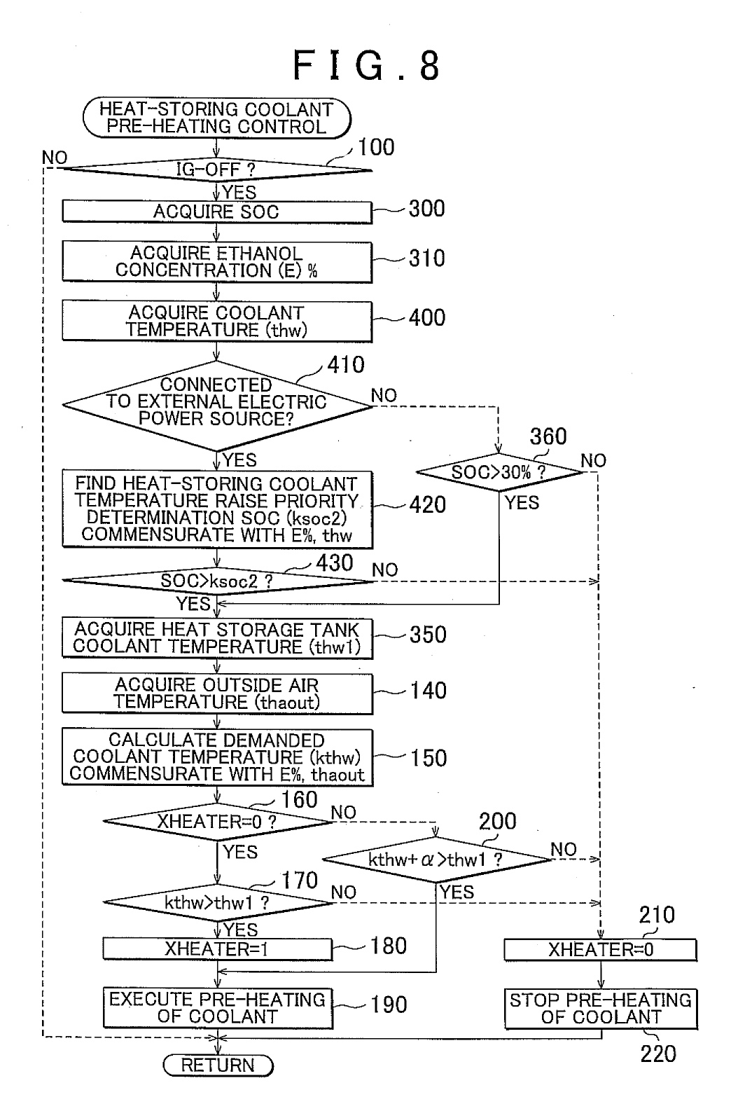

Next, a third embodiment of the invention will be described with reference to FIGS. 7 and 8. A hybrid system of this embodiment can be realized by causing the ECU 50 to carry out a routine described later with reference to FIG. 8, in the construction as shown in FIGS. 1 and 2.

According to the foregoing system of the second embodiment, the heat-storing coolant temperature raise priority criterion state of charge ksoc1 can be set lower the higher the ethanol concentration E is, so that when the ethanol concentration E is high, priority is given to the coolant pre-heating. Incidentally, in the case where the coolant for the engine 12 is high, a good startability of the engine 12 is secured. Therefore, the startability of the engine 12 may be taken into account. Therefore, in the hybrid system of this embodiment, a heat-storing coolant temperature raise priority criterion state of charge is set on the basis of the coolant temperature of the engine 12 and the ethanol concentration.

The control will be concretely described. FIG. 7 is a diagram for describing a “heat-storing coolant temperature raise priority map” for use in the system of the third embodiment. The heat-storing coolant temperature raise priority map shown in FIG. 7 represents relations among the coolant temperature thw of the engine 12 the ethanol concentration E in fuel, and the heat-storing coolant temperature raise priority criterion state of charge ksoc2. The heat-storing coolant temperature raise priority criterion state of charge ksoc2 is set higher the higher the coolant temperature thw of the engine 12. Besides, the heat-storing coolant temperature raise priority criterion state of charge ksoc2 is set higher the lower the ethanol concentration E in the fuel.

In the hybrid system of this embodiment, the heat-storing coolant temperature raise priority criterion state of charge ksoc2 is used as a criterion value. If the coolant temperature thw is higher and the ethanol concentration E in the fuel is lower, in which case the fuel readily vaporizes, the criterion value ksoc2 is set higher to correspondingly restrain the execution of the coolant pre-heating. On the other hand, if the coolant temperature thw is lower and the ethanol concentration E is higher, in which case the fuel less readily vaporizes, the criterion value ksoc2 is set lower to correspondingly promote the execution of the coolant pre-heating. Specifically, if the heat-storing coolant temperature raise priority criterion state of charge ksoc1 is greater than a predetermined state of charge, the coolant pre-heating is executed, and the predetermined state of charge is set higher the higher the coolant temperature thw.

FIG. 8 is a flowchart of a heat-storing coolant pre-heating control routine that the ECU 50 executes in order to realize the foregoing operations. This routine is substantially the same as the routine shown in FIG. 6, except that the process of step 320 to step 340 in FIG. 6 is replaced by a process of steps 400 to 430. Hereinafter, the steps in FIG. 8 that are the same as those shown in FIG. 6 are denoted by the same reference characters, and their descriptions will be omitted or simplified.

In the routine shown in FIG. 8, after the process of step 310, the coolant temperature thw of the engine 12 is acquired (step 400). The coolant temperature thw is detected by the cooling passageway temperature sensor 66.

Subsequently in step 410, it is determined whether or not the battery 30 and an external electric power source are connected to each other. Concretely, the state of connection between the battery 30 and an external electric power source is detected by the charging circuit 32. As described above, when the battery 30 is connected to an external electric power source, the battery 30 is supplied with electric power from the external electric power source, and is thus charged.

If it is determined that an external electric power source has been connected to the battery 30, a heat-storing coolant temperature raise priority criterion state of charge ksoc2 is calculated in step 420. Concretely, the heat-storing coolant temperature raise priority map described above with reference to FIG. 7 is pre-stored in the ECU 50. From the heat-storing coolant temperature raise priority map, a heat-storing coolant temperature raise priority criterion state of charge ksoc2 that corresponds to the ethanol concentration E acquired in step 310 and the coolant temperature thw acquired in step 400 is acquired.

Subsequently, it is determined whether or not the state of charge SOC of the battery 30 acquired in step 300 is greater than the heat-storing coolant temperature raise priority criterion state of charge ksoc2 (step 430). If it is determined that the state of charge SOC is greater than the heat-storing coolant temperature raise priority criterion state of charge ksoc2, substantially the same process as that starting in step 350 in FIG. 6 is then performed. If the foregoing condition is satisfied, the coolant pre-heating is executed (step 190).

On the other hand, if in step 430 it is determined that the state of charge SOC of the battery 30 is less than or equal to the heat-storing coolant temperature raise priority criterion state of charge ksoc2, substantially the same process as that starting in step 210 in FIG. 6 is then performed, and the coolant pre-heating is stopped.

According to the routine shown in FIG. 8, the heat-storing coolant temperature raise priority criterion state of charge ksoc2 can be set higher the higher the coolant temperature thw is and the lower the ethanol concentration E is. In the case where the coolant temperature thw is higher and the ethanol concentration E is lower, the fuel vaporizes correspondingly more readily and the startability of the engine 12 is correspondingly better. In that case, therefore, by setting the heat-storing coolant temperature raise priority criterion state of charge ksoc2 relatively high, the priority of the coolant pre-heating is reduced so as to restrain the electric power consumption of the heater 76. Therefore, the charging of the battery 30 can be promoted.

Besides, according to the routine shown in FIG. 8, the heat-storing coolant temperature raise priority criterion state of charge ksoc2 can be set lower the lower the coolant temperature thw and the higher the ethanol concentration E. In the case where the coolant temperature thw is lower and the ethanol concentration E is higher, the fuel correspondingly less readily vaporizes and the startability of the engine 12 correspondingly deteriorates. Therefore, in that case, by setting the heat-storing coolant temperature raise priority criterion state of charge ksoc2 relatively low, the coolant pre-heating can be preferentially executed and the securement of an amount of heat needed for the warm-up of the engine 12 can be preferentially performed.

Thus, according to the hybrid system of this embodiment, since the heat-storing coolant temperature raise priority criterion state of charge ksoc2 is appropriately set in accordance with the coolant temperature thw and the ethanol concentration E, improvement of the startability of the internal combustion engine and improvement of the fuel economy following a start of traveling of the vehicle can be realized.

Incidentally, in the third embodiment described above, the ECU 50 realizes an external electric power source connection determination device in the invention by executing the process of step 410.

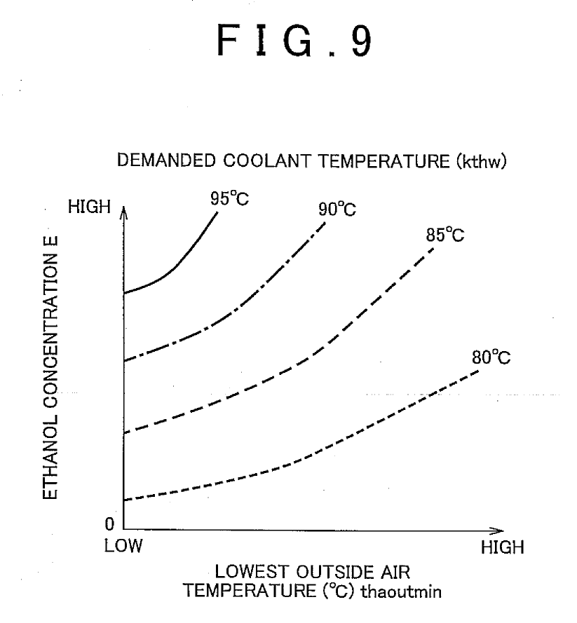

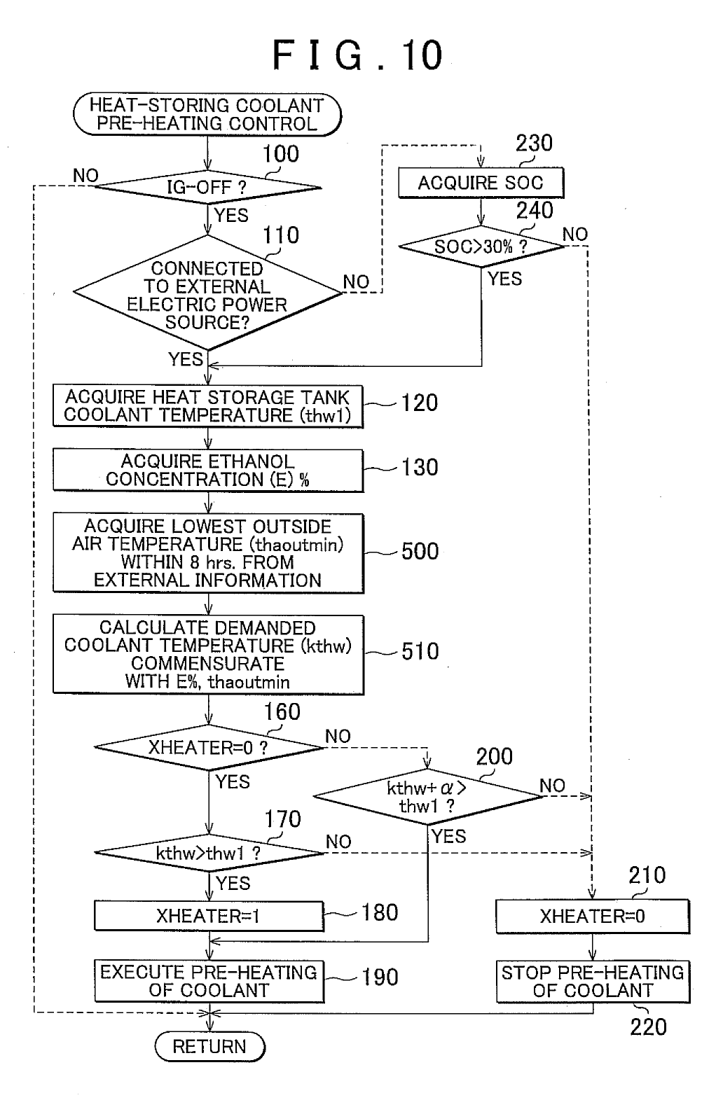

Next, with reference to FIG. 9 to FIG. 10, a fourth embodiment of the invention will be described. A hybrid system of this embodiment can be realized in the construction shown FIGS. 1 and 2 by causing the ECU 50 to carry out a routine shown in FIG. 10.

In the case where the heat storage system 58 is mounted in a vehicle, it is desired to reduce the size and the capacity of the heater 76 and reduce the size of the heat storage tank 74. However, the warm-up of the engine needs a predetermined amount of heat as mentioned above. In the case where a small-size heat storage tank 74 is employed, since the amount of coolant stored therein is small, there arises a need to raise the coolant temperature in order to obtain the needed amount of heat. In this case, the small-size and small-capacity heater 76, which does not easily raise the coolant temperature, requires that the coolant pre-heating be performed for a long time. Therefore, the hybrid system of this embodiment, using information from an external device, the coolant pre-heating speculates a lowest outside air temperature during the period of a predetermined time from the present.

The control will be more concretely described. FIG. 9 is a diagram for describing a demanded coolant temperature map for use in the system of the fourth embodiment. The demanded coolant temperature map in FIG. 9 represents a relation among the predicted lowest outside air temperature thaoutmin during the period of a predetermined time from the present, the ethanol concentration E in the fuel, and the demanded coolant temperature kthw. The lowest outside air temperature thaoutmin is the lowest temperature in the period of a predetermined time from the present time which is predicted from information obtained from an external device (e.g., whether information, and the like). The demanded coolant temperature kthw is a temperature of the coolant kept in the heat storage tank 74 which is required in order to secure the amount of heat that is needed for the warm-up of the engine 12 prior to starting the engine 12.

As shown in FIG. 9, the demanded coolant temperature kthw is set higher the lower the lowest outside air temperature thaoutmin. Besides, the demanded coolant temperature kthw is set higher the higher the ethanol concentration E in the fuel. In this embodiment, the lower the lowest outside air temperature thaoutmin and the higher the ethanol concentration, the demanded coolant temperature kthw is set higher to accordingly execute the coolant pre-heating.

FIG. 10 is a flowchart of a heat-storing coolant pre-heating control routine that the ECU 50 executes in order to realize the foregoing operations. This routine is substantially the same as the routine shown in FIG. 4, except that the process of steps 140 to 150 in FIG. 4 is replaced by a process of steps 500 to 510. Steps in FIG. 10 that are the same as those shown in FIG. 4 are denoted by the same reference characters, and descriptions thereof will be omitted or simplified below.

In the routine shown in FIG. 10, after the process of step 130, a lowest outside air temperature thaoutmin that is predicted to occur in a period of a predetermined time from the present on the basis of external is acquired (step 500). Examples of the external information include weather forecast information acquired through a communication line, past statistic data, etc. The hybrid system of the embodiment is equipped with a communication facility that is able to acquire weather forecast information or the like. From the data acquired, the hybrid system acquires a predicted lowest outside air temperature thaoutmin in the period of a predetermined time from the present. Incidentally, the foregoing predetermined time can be determined beforehand by experiments or the like. An example of the foregoing predetermined time is a time that is taken from the complete warm-up of the engine to when the coolant temperature declines to a normal temperature.

Subsequently in step 510, a demanded coolant temperature kthw is calculated. Concretely, the “demanded coolant temperature map” mentioned above with reference to FIG. 9 is pre-stored in the ECU 50. From the demanded coolant temperature map, a demanded coolant temperature kthw that corresponds to the ethanol concentration E acquired in step 130 and the lowest outside air temperature thaoutmin acquired in step 500 is acquired. Incidentally, the demanded coolant temperature kthw is determined beforehand by experiments or the like so as to secure an amount of heat that is needed for the sufficient warm-up of the engine 12, with the structure of the engine 12, the amount of coolant stored in the heat storage tank 74, etc., taken into account as well.

After that, substantially the same process as that starting in step 160 in FIG. 4 is performed. If the condition is satisfied, the coolant pre-heating is executed (step 190).

As described above, according to the routine shown in FIG. 10, the demanded coolant temperature kthw can be set higher the lower the lowest outside air temperature thaoutmin and the higher the ethanol concentration E. Since the coolant pre-heating is executed on the basis of the lowest outside air temperature thaoutmin predicted to occur during the period of a predetermined time from the present in addition to the ethanol concentration E, an amount of heat needed for the warm-up of the engine 12 can be certainly obtained while a future drop of the external air temperature taken into account, even in the case where the heat storage tank 74 is small in size and the heat 7 is small in size and in capacity as well. Besides, by always updating the lowest outside air temperature, optimal startability of the engine 12 can be secured even in the case where the outside air temperature greatly changes.

Incidentally, in the fourth embodiment described above, the ECU 50 realizes a “lowest outside air temperature acquisition device” in the invention by executing the process of step 500, and a “demanded coolant temperature setting device” in the invention by executing the process of step 510.

Besides, in this invention, the coolant pre-heating device may increase amount of electric power supplied to the coolant heater as the demanded coolant temperature increases.

According to the invention, the amount of electric power supplied to the coolant heater can be increased as the demanded coolant temperature increases. The higher the temperature of the coolant is, the greater the temperature drop per unit time is (see FIGS. 11 and 12). The temperature of the coolant can be raised in the manner in which the amount of electric power supplied to the coolant heater is increased as the demanded coolant temperature increases.

Besides, in the invention, the coolant pre-heating device may increase amount of electric power supplied to the coolant heater and may decrease the amount of electric power stored into the storage battery as the demanded coolant temperature increases, when the amount of electric power supplied from the external electric power source is fixed.

According to the invention, it is possible to increase the amount of electric power supplied to the coolant heater and decrease the amount of electric power stored into the storage battery with increases in the demanded coolant temperature, when the amount of electric power supplied from an external electric power source is fixed. Therefore, an amount of heat needed for the warm-up of the engine can be secured, and therefore the startability of the internal combustion engine can be heightened.

Besides, in the invention, the hybrid system may include an outside air temperature acquisition device that acquires the outside air temperature. The demanded coolant temperature setting device may set the demanded coolant temperature higher as the outside air temperature decreases or the alcohol concentration increases.

According to the invention, the demanded coolant temperature can be set higher, the lower the outside air temperature. Therefore, even in a situation where the outside air temperature is extremely low that the startability of the internal combustion engine deteriorates, an amount of heat needed for the warm-up of the engine can be secured, and the startability of the engine can be heightened.

Besides, in the invention, the hybrid system may include a lowest outside air temperature acquisition device that predicts a lowest outside air temperature within a predetermined time from a present time. The demanded coolant temperature setting device may set the demanded coolant temperature higher as the predicted lowest outside air temperature decreases or the alcohol concentration increases.

According to the invention, the demanded coolant temperature can be set higher, the lower the predicted lowest outside air temperature in the predetermined time from the present time. Therefore, the temperature of the coolant can be sufficiently raised in advance even in the case where a small-size and small-capacity coolant heater is employed.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A controller for a hybrid system that includes:
an internal combustion engine that uses a fuel mixed with alcohol;
a coolant heater that heats coolant for the internal combustion engine when the heater is supplied with electric power; and
a storage battery that supplies electric power to the coolant heater, and that is charged at least when the storage battery is connected to an external electric power source,
the controller for the hybrid system comprising:
an alcohol concentration detector that detects alcohol concentration of the fuel;
a demanded coolant temperature setting device that sets a demanded coolant temperature higher as the alcohol concentration increases;
an internal combustion engine stopped state determination device that determines whether the internal combustion engine is stopped;
an external electric power source connection determination device that determines whether the storage battery is connected to the external electric power source; and
a coolant pre-heating device that supplies electric power to the coolant heater until coolant temperature of the coolant reaches the demanded coolant temperature if the internal combustion engine is in the stopped state and the storage battery is connected to the external electric power source.

2. The controller for the hybrid system according to claim 1, wherein the coolant pre-heating device increases amount of electric power supplied to the coolant heater as the demanded coolant temperature increases.

3. The controller for the hybrid system according to claim 1, wherein the coolant pre-heating device increases amount of electric power supplied to the coolant heater and decreases the amount of electric power stored into the storage battery as the demanded coolant temperature increases, when the amount of electric power supplied from the external electric power source is fixed.

4. The controller for the hybrid system according to claim 1, wherein:
the coolant pre-heating device executes coolant pre-heating when state of charge of the storage battery is greater than a predetermined state of charge; and
the predetermined state of charge is set lower as the alcohol concentration increases.

5. The controller for the hybrid system according to claim 4, further comprising a coolant temperature acquisition device that acquires the coolant temperature,
wherein the predetermined state of charge is set higher as the coolant temperature increases.

6. The controller for the hybrid system according to claim 1, further comprising an outside air temperature acquisition device that acquires an outside air temperature,
wherein the demanded coolant temperature setting device sets the demanded coolant temperature higher as the outside air temperature decreases or the alcohol concentration increases.

7. The controller for the hybrid system according to claim 1, further comprising a lowest outside air temperature acquisition device that predicts a lowest outside air temperature within a predetermined time from a present time,
wherein the demanded coolant temperature setting device sets the demanded coolant temperature higher as the predicted lowest outside air temperature decreases or the alcohol concentration increases.

8. A controller for a hybrid system that includes:
an internal combustion engine that uses a fuel mixed with alcohol;
coolant heating means for heating coolant for the internal combustion engine when the heating means is supplied with electric power; and
a storage battery that supplies electric power to the coolant heating means, and that is charged at least when the storage battery is connected to an external electric power source,
the controller for the hybrid system comprising:
alcohol concentration detection means for detecting alcohol concentration of the fuel;
demanded coolant temperature setting means for setting a demanded coolant temperature higher as the alcohol concentration increases;
internal combustion engine stopped state determination means for determining whether the internal combustion engine is stopped;
external electric power source connection determination means for determining whether the storage battery is connected to the external electric power source; and
coolant pre-heating means for supplying electric power to the coolant heating means until coolant temperature of the coolant reaches the demanded coolant temperature if the internal combustion engine is in the stopped state and the storage battery is connected to the external electric power source.
